(19) United States
(12) Patent Application Publication
(10) Pub. No.: US 2011/0116106 A1
(43) Pub. Date: May 19, 2011

(54) Print Job Mapping Mechanism

(76) Inventors: Andrew James Griess, Boulder, CO (US); Janeen Elizabeth Jahn, Lafayette, CO (US)

(21) Appl. No.: 12/617,881

(22) Filed: Nov. 13, 2009

(51) Int. Cl. G06K 15/02

(52) U.S. Cl. 358/1.2; 358/1.9; 358/1.13

(57) ABSTRACT

A method disclosed. The method includes receiving a Job Definition Format (JDF) attribute and associating the JDF attribute with a mapping class that generates a mapping between the JDF attribute and a one or more corresponding printing attributes.

### FIELD OF THE INVENTION

The invention relates to the field of printing systems, and in particular, to print job management.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is typically implemented at a print server to manage a print job from job entry and management through the complete printing process. More frequently, Job Definition Format (JDF) is being used to describe print jobs. JDF is an Extensible Markup Language (XML) based file format that describes a print job's characteristics (e.g., quantity, paper type , data files, etc.).

JDF features job tickets that describe data files that are included in a print job, as well as how the print job is to be printed. Thus, in order to support JDF print job tickets, printing software products need to map attributes from JDF to comparable attributes utilized by the printing software products. However since JDF attributes may vary for each user of the printing software product, it is often necessary to manually customize mapping for each different user. Having to manually customize mapping for each user is often impracticable and inefficient.

Accordingly, an efficient mechanism for mapping JDF to printing software attributes is desired.

### SUMMARY

In one embodiment, a method includes receiving a Job Definition Format (JDF) attribute and associating the JDF attribute with a mapping class that generates a mapping between the JDF attribute and one or more corresponding printing attributes.

Another embodiment discloses a print server including printing software product to receive a Job Definition Format (JDF) attribute and associate the JDF attribute with a mapping class that generates a mapping between the first JDF attribute and a set of one or more corresponding printing attributes.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrate embodiments of mapping databases;

FIG. 3 is a flow diagram illustrating one embodiment of attribute mapping; and

FIG. 4 illustrates one embodiment of a computer system.

### DETAILED DESCRIPTION

A print job mapping mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

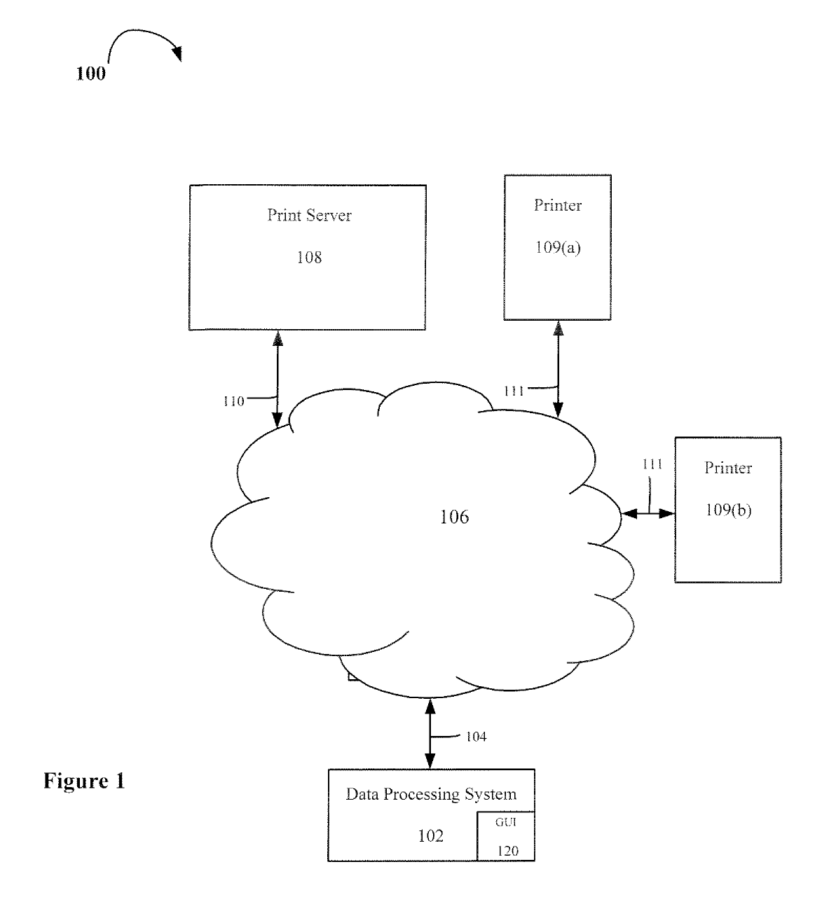

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, the operating system on data processing system 102 allows a user to select the desired print server 108 and submit requests for service requests to printer 109 via print server 108 over network 106. In a further embodiment, print server 108 includes a print queue for print jobs requested by remote data processing systems.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and one or more of printers 109. In other embodiments, the printing software product manages the printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, data processing system 102 includes a print application that interacts with the printing software product at printer server 108 to provide for efficient transmission of print jobs.

In one embodiment, the printing software product includes a graphical user interface (GUI) 120 that enables a system administrator (or operator) to interact with the printing software product and the print application. In a further embodiment, the print application generates print jobs in JDF as job tickets. As discussed above, JDF job tickets implement print job attributes that are different from those in the printing software product. Therefore, the printing software product features a process that maps attributes from JDF to comparable attributes supported by the printing software product.

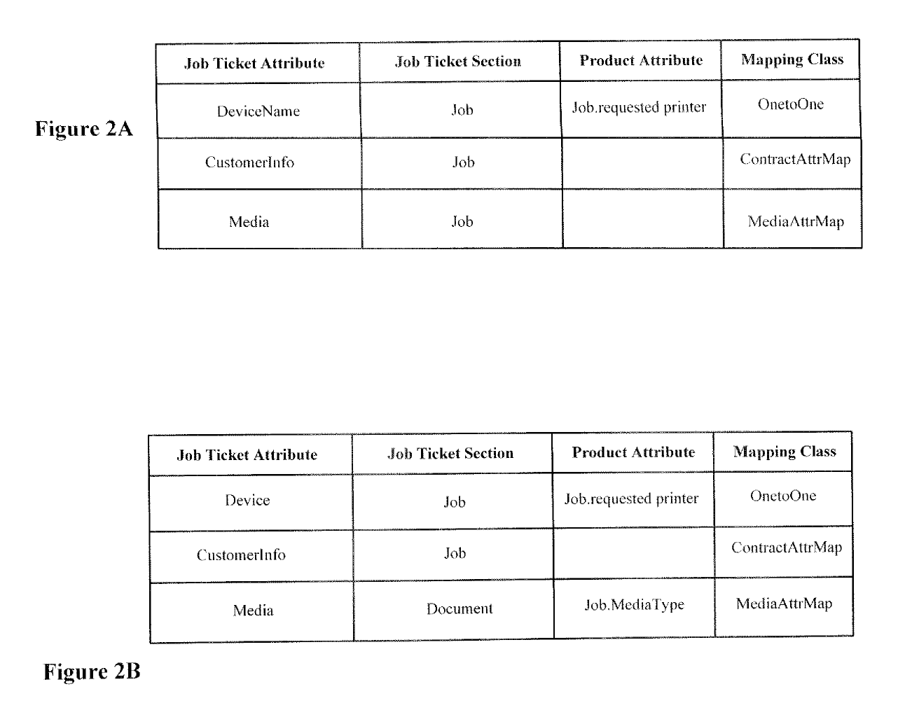

According to one embodiment, the printing software product generates a database that maps JDF job ticket values to the printing software product's attributes. In such an embodiment, the database parameters can be edited directly, or alternatively exported, changed, and then imported. FIG. 2A illustrates one embodiment of a mapping database.

In one embodiment, mapping rows in the database are generated upon receiving a comma-delimited file. Therefore, all mapping relationships are defined prior to the submission of print jobs to the printing software application. In a further embodiment, the file may be generated using GUI 120. However in other embodiments, the file may be generated external to the printing software product.

Once the printing software product is initiated, the comma-delimited file is read into the database. In still a further embodiment, the mapping relationships may be changed at anytime by editing a comma delimited file (or spreadsheet) through a non-programmatic interface and importing the contents back into the database. Yet, in other embodiments the mapping relationships may be changed through GUI 120.

As shown in FIG. 2A, each row in the database includes a JDF attribute (Job Ticket Attribute) as a primary key, and additional fields providing information as to how to map the particular attribute to one or more attributes known to the printing software product. In one embodiment, the information includes a category of the JDF attribute (Job Ticket Section) used to determine what precedence the attribute has based on its scope, a printing software product attribute(s) (Product Attribute) that correspond to the JDF attribute and a mapping (Mapping Class) used to perform the processing of the mapping. For instance, 1-to-1, 1-to-n, n-to-1 and n-to-n mapping combinations may be implemented.

In one embodiment of 1-to-1 mapping, the printing software product uses a value in an attribute in a job ticket to set a single printing software product property. As shown in the first row of FIG. 2A, the Job Ticket DeviceName attribute has a 1-to-1 mapping with the Product Attribute (Job.requested printer), as indicated by the Mapping Class (OnetoOne).

For 1-to-n mapping, the printing software product uses a value in a job ticket and to set two or more printing software product attributes. For example, the representation of the Job Ticket CustomerInfo attribute, shown in the second row of FIG. 2A, may be mapped to printing software product attributes Job.Info.Department and Job.CustomerName (not shown) through ContactAttrMap specified in the Mapping Class column of the second row of the table, while the Product Attribute is left blank since the specified mapping class indicates which multiple attributes are mapped to the single attribute.

For n-to-1 mapping, the printing software product compares values of attributes in a Media Resource in a job ticket to the attributes of media sizes that are defined in the printing software product and sets Media size to the name of the media size that matches the job ticket values, if any. For instance, the representation of the Media Job Ticket attribute at the job level shown in the third row of FIG. 2A, includes dimensional attributes describing the size of the media, with that information being used to set a value for a Media Size attribute (e.g., Job.MediaSize (not shown)) of the printing software product through MediaAttrMap specified in the Mapping Class column of the third row of the table, while the Product Attribute is left blank since the specified mapping class indicates which multiple attributes are mapped to the single attribute.

For n-to-n mapping, the printing software product may set additional properties besides Media size as a result of the n-to-1 mapping described above. In such an embodiment, the representation of the Media Job Ticket attribute at the job level also includes attributes describing the media the print job should be printed on, as well as the color of the paper, if holes need to be punched, if the paper needs to be recycled, etc.

That information is then used to set a Media Type attribute (Job.MediaType) in the printing software product. Further, the job ticket media size information may continue to be used to set the Media Size attribute as described in the n-1 embodiment above. Thus, printing software product IPPD attributes are being set based on information in multiple JDF job ticket attributes.

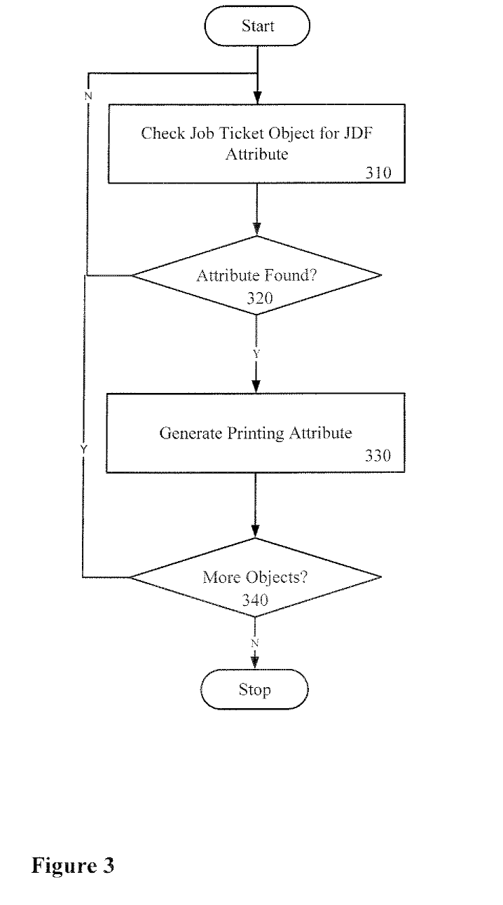

FIG. 3 is a flow diagram illustrating the operation for generating attribute mapping. At processing block 310, a JDF job ticket object is examined. In one embodiment, a JDF attribute of each category is analyzed starting with the category with the broadest scope (e.g., job ticket) and working inwards towards the category with the narrowest scope (e.g., document). This ensures that a setting with the most specific scope takes precedence. For instance if a media type was specified for both the overall print job as well as for a specific document, the document setting would take precedence.

At decision block 320, it is determined whether the object is associated with a JDF attribute. If no attribute is found, control is returned to processing block 310 where another object is examined. However if an attribute is found, a Mapping Class associated with the JDF attribute is used to map the JDF attribute to a corresponding printing software product attribute and value, processing block 330. At decision block 340, it is determined whether there are additional JDF objects remaining to be analyzed. If so, control is returned to processing block 310 where another object is examined. Otherwise the mapping process is completed.

FIG. 2B illustrates another embodiment of a mapping database. In this embodiment, the database has been edited so that Job.requested printer in the first row is set to Device JDF attribute. Moreover, the Media Job Ticket Attribute at the document level is set for n-to-1 to Job.MediaType via the MediaAttrMap Mapping Class.

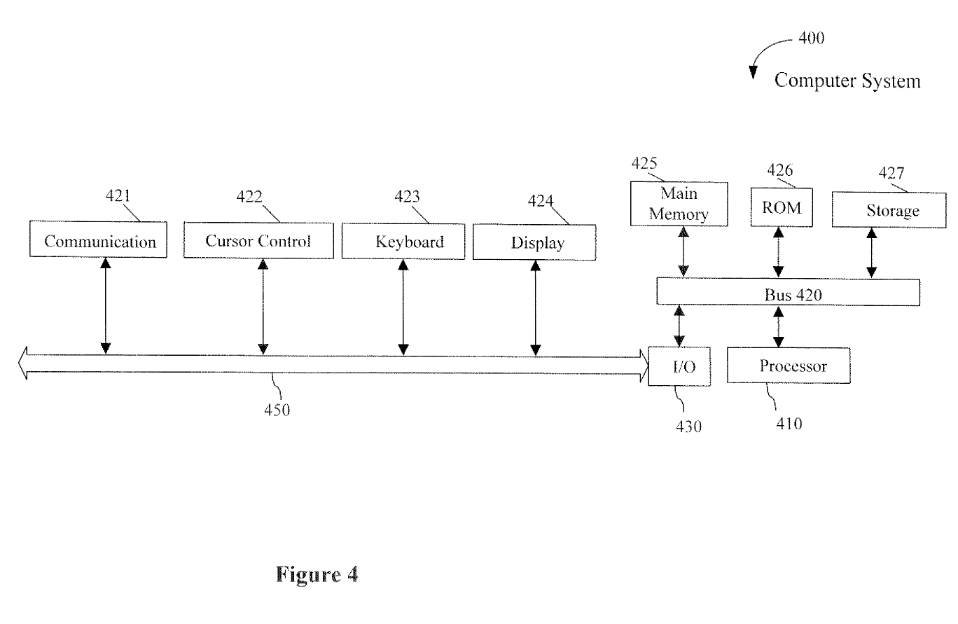

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

The above-described mechanism enables simple customization of mapping from JDF attributes to attributes of a printer software product through an interface that can be easily modified for different user installations.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving a first Job Definition Format (JDF) attribute;
associating the first JDF attribute with a mapping class; and
the mapping class generating a mapping between the first JDF attribute and a first set of one or more corresponding printing attributes.

2. The method of claim 1 wherein the mapping class generates a 1-to-1 mapping between the first JDF attribute and a corresponding printing attribute.

3. The method of claim 1 wherein the mapping class generates a n-to-1 mapping between two or more JDF attributes and a corresponding printing attribute.

4. The method of claim 3 wherein the mapping class generating a n-to-1 mapping comprises:
comparing values of JDF attributes in a media resource component of a JDF job ticket to media sizes defined in printing attributes; and
setting a printing attribute for a media size that matches the JDF attribute values.

5. The method of claim 1 wherein the mapping class generates a n-to-n mapping between two or more JDF attributes and two or more corresponding printing attribute.

6. The method of claim 1 further comprising:
receiving a second JDF attribute;
associating the second JDF attribute with a second mapping class; and
the second mapping class generating a second mapping between the second JDF attribute and one or more corresponding printing attributes

7. The method of claim 1 further comprising:
receiving a second JDF attribute;
associating the second JDF attribute with the mapping class;
the mapping class generating a second mapping between the second JDF attribute and the one or more corresponding printing attributes; and
replacing the first JDF attribute with the second JDF attribute.

8. A print server comprising a printing software product to receive a first Job Definition Format (JDF) attribute and associate the first JDF attribute with a mapping class that generates a mapping between the first JDF attribute and a first set of one or more corresponding printing attributes.

9. The print server of claim 8 wherein the mapping class generates a 1-to-1 mapping between the first JDF attribute and a corresponding printing attribute.

10. The print server of claim 9 wherein the printing software product uses a value in an attribute in a job ticket to set a single printing software product property when the mapping class generates a 1-to-1 mapping.

11. The print server of claim 8 wherein the mapping class generates a n-to-1 mapping between two or more JDF attributes and a corresponding printing attribute.

12. The print server of claim 11 wherein the mapping class generating a n-to-1 mapping comprises:
comparing values of JDF attributes in a media resource component of a JDF job ticket to media sizes defined in printing attributes; and
setting a printing attribute for a media size that matches the JDF attribute values.

13. The print server of claim 8 wherein the mapping class generates a n-to-n mapping between two or more JDF attributes and two or more corresponding printing attribute.

14. An article of manufacture comprising a machine-readable medium including data that, when accessed by a machine, cause the machine to perform operations comprising:
receiving a first Job Definition Format (JDF) attribute;
associating the first JDF attribute with a mapping class; and
the mapping class generating a mapping between the first JDF attribute and a first set of one or more corresponding printing attributes.

15. The article of manufacture of claim 14 wherein the mapping class generates a 1-to-1 mapping between the first JDF attribute and a corresponding printing attribute.

16. The article of manufacture of claim 14 wherein the mapping class generates a n-to-1 mapping between two or more JDF attributes and a corresponding printing attribute.

17. The article of manufacture of claim 15 wherein the mapping class generating a n-to-1 mapping comprises:
comparing values of JDF attributes in a media resource component of a JDF job ticket to media sizes defined in printing attributes; and
setting a printing attribute for a media size that matches the JDF attribute values.

18. The article of manufacture of claim 14 further comprising:
receiving a second JDF attribute;
associating the second JDF attribute with a second mapping class; and
the second mapping class generating a second mapping between the second JDF attribute and one or more corresponding printing attributes.

19. The article of manufacture of claim 14 further comprising:
receiving a second JDF attribute;
associating the second JDF attribute with the mapping class;
the mapping class generating a second mapping between the second JDF attribute and the one or more corresponding printing attributes; and
replacing the first JDF attribute with the second JDF attribute.

20. The article of manufacture of claim 14 wherein the mapping class generates a n-to-n mapping between two or more JDF attributes and two or more corresponding printing attribute.
